(19) United States
(12) Patent Application Publication
(10) Pub. No.: US 2019/0188132 A1
(43) Pub. Date: Jun. 20, 2019

(54) SQL SCAN HARDWARE ACCELERATOR

(71) Applicant: Intel Corporation, Santa Clara, CA (US)

(72) Inventors: Kirk Yap, Westborough, MA (US); James D. Guilford, Northborough, MA (US); Simon N. Peffers, Action, MA (US); Vinodh Gopal, Westborough, MA (US)

(21) Appl. No.: 15/845,271

(22) Filed: Dec. 18, 2017

(51) Int. Cl. G06F 12/084; G06F 17/30; G06F 13/16; G06F 3/06

(52) U.S. Cl. CPC G06F 12/084; G06F 17/30442; G06F 2212/621; G06F 3/0629; G06F 13/1652; G06F 13/1668

(57) ABSTRACT

Various systems and methods for hardware acceleration circuitry are described. In an embodiment, circuitry is to perform 1-bit comparisons of elements of variable M-bit width aligned to N-bit width, where N is a power of 2, in a data path of P-bit width. Second and subsequent scan stages use the comparison results from the previous stage to perform 1-bit comparison of adjacent results, so that each subsequent stage results in a full comparison of element widths double that of the previous stage. A total number of stages required to scan, or filter, M-bit elements in N-bit width lanes is equal 1+log 2(N), and the total number of stages required for implementation in the circuitry is 1+log 2(P), where P is the maximum width of the data path comprising 1 to P elements.

### TECHNICAL FIELD

Embodiments described herein generally relate to databases, and, more particularly, towards in-memory databases (IMDB).

### BACKGROUND

In-memory databases (IMDB) may be used in many applications. Some relational database products may use IMDBs to provide extremely high queries/second to support rapid decision making based on real-time analytics. IMDB may be provided in products available from Oracle Corp. and SAP SE. SAP-HANA, for instance is an in-memory, column-oriented, relational database management system. Its primary function as database server is to store and retrieve data as requested by the applications.

These in memory databases are structured as “column-stores” which may provide the best query processing time. On the other hand, row-oriented databases may be better for transaction processing time. One of the most used functions that is used in the SQL queries, is a “scan” operation. The scan is typically performed on a huge amount of data (e.g., full-table scans or numerous columns of tables) of the order of many gigabytes. The scan operation processes a column and generates an output based on some predicates signifying the elements (or rows) that are matched. These types of operations are also known as SQL filters, as they typically produce a very small amount of matching elements relative to the table sizes. Scan or filtering operations may be extremely time intensive using software processing.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a high level diagram illustrating scan processing, according to an embodiment;

FIG. 2 is a high level diagram illustrating operations of pre-processing logic, according to an embodiment;

FIG. 3 illustrates the data alignment logic for an example of 3-bit elements, according to an embodiment;

FIG. 4 illustrates how the aligned scan_low_value is compared with the first and second 3-bit elements in an 8-bit data path, in one cycle, according to an embodiment;

FIG. 5 illustrates an n-stage scan tree for an example of 32-bit data path, according to an embodiment;

FIG. 6 illustrates the logic gates at a first stage, and logic gates at a second stage, for a portion of the scan processor, according to an embodiment;

FIG. 7 is a block diagram of a register architecture in a system on which various embodiments described herein may be implemented;

FIG. 8 is a block diagram illustrating both an exemplary in-order pipeline and an exemplary register renaming, out-of-order issue/execution pipeline according to some embodiments;

FIG. 9 is a block diagram illustrating the in-order pipeline and in-order core, as well as, optional addition the register renaming, out-of-order issue/execution pipeline and core; and

FIGS. 10-13 are block diagrams of exemplary computer architectures on which various embodiments may be implemented.

### DETAILED DESCRIPTION

Embodiments as described herein are directed toward an efficient hardware accelerator that offloads the computation from the processor cores and may provide a balanced performance across the entire range of element widths. In an embodiment, the hardware accelerator may reside in the un-core of the central processing unit (CPU) of a system on a chip (SOC). In alternative embodiments, the hardware accelerator may reside in other processors, co-processors, chipsets, or compute nodes in the system, as discussed more below.

For in memory relational databases that are structured as column stores, the columns are generally viewed as an array of unsigned integers of any bit-width, e.g., a column of states of the U.S. may be represented as an array of 6-bit elements. This is a dictionary encoded efficient representation because the cardinality of the states is a small one. While the predicates may be as simple as checking for equality, there are some challenges in implementing an optimal solution:
the arbitrary bit-width of the elements (e.g. from 1-32 bits) makes it very challenging to find good software implementations; and
processing the filter/scan with CPU Cores may not be efficient due to the amount of data that is read into the cores, and often bottlenecked by the per-core read memory bandwidth for simpler scans.

In typical software implementations for IMDBs, the limits of software processing speeds have been effectively been reached for SIMD instruction sets such as AVX512. There may be significant performance gain from a hardware accelerator compared to software, including the large power efficiency of avoiding moving a huge data stream to the cores for filtering.

Other IMDB products may be using hardware accelerators. For instance, Oracle IMDB uses a SPARC M7 processor with Software in Silicon (SWiS) solutions such as a data analytics accelerator (DAX) coprocessor. However, Oracle IMDB is optimized for smaller dictionary sizes, e.g., in the range of 3-12 bits. Such small dictionary optimization will not scale well to larger elements. Such IMDB solutions like SAP-HANA offered by SAP SE are optimized for larger elements more often and focus on performance of large width elements. In contrast, embodiments as described herein provide an efficient solution to all the database implementations, and scale well for large and small element widths.

Embodiments described herein include a hardware accelerator for SQL Scan that is area efficient, and may give good performance across the entire range of element bit-widths from 1 to 32, for a 32-bit data path. While a 1-32 bit solution is discussed, it will be understood that the accelerator may be scaled to a 64-bit or 128-bit solution, etc. In an example, a Scan operation may be to check which elements in the column array are equal to a target value. The output may be a bit-vector of a length the same as the number of elements in the input column array (e.g., number of rows), where a 1 value signifies a match.

In an embodiment, the data is dictionary encoded. In other words, a dictionary of unique entries is generated and an array of integers represents indices to the data in the dictionary. Thus, indices to the 50 states of the U.S. may be represented in 6 bits (binary digits), e.g., 0 to 49₁₀. However, to pack the data, a new index will begin at the 7^{th} bit, rather than using 8-bits (e.g., a byte boundary) for each entry.

In an embodiment, the scan operation may be effected through an application program interface (API) call. From the API level, a hardware engine may be called, where the call identifies the type of scan predicate needed (e.g. equality with target element), and a pointer to the column data. The API call may also specify the size of the column in terms of number of elements and the bit-width of the elements. An IMDB may be stored as an array of integers. The data is typically packed to reduce size, which results in the elements not being byte aligned, which is why the width (e.g., bit-width of the element) is specified.

In an embodiment, logic circuitry is shared in scan processing between different element widths. For instance, in prior systems an efficient 32-bit scan would have logic dedicated to 32-bits, and a 16-bit scan accelerator would have logic dedicated to 16-bits. The 16-bit and 32-bit accelerators may be extremely efficient, but each bit width would require dedicated circuitry, and therefore increase hardware costs, weight, footprint, heat production, etc., for the device. In an embodiment, the scan accelerator logic used to process smaller elements is directly used and shared by wider/larger elements. For example, results from 1-bit element processing are used for 2-bit elements, which are used for 3-bit or 4-bit elements. In order to maximize sharing of logic, the number of elements processed is not designed to be maximized. Instead the logic is designed to process up to the largest number of elements that is a power of 2. For example, for a 32-bit wide data path, there may be 32 1-bit elements. All 32 1-bit elements are processed since 32 is a power of 2. Similarly, for 2-bit elements, all 16 elements are processed because 16 is a power of 2. However, for scans with 3-bit elements, where there are 10 elements in a 32-bit wide bus, only 8 elements will be processed in a cycle, since 8 is the largest power of 2 that is less than or equal to 10.

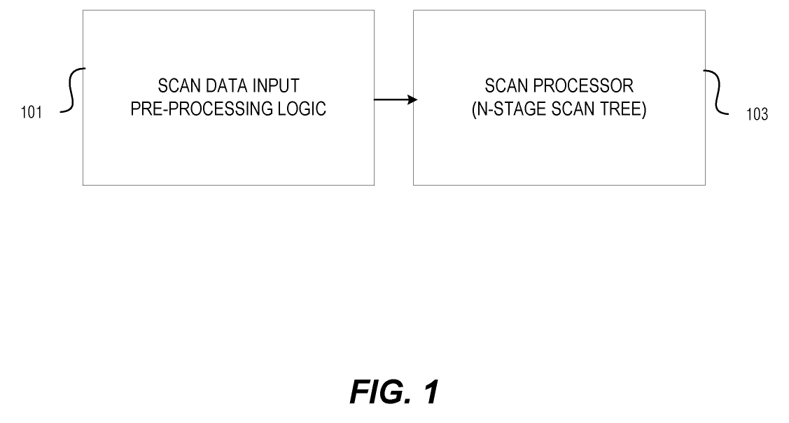

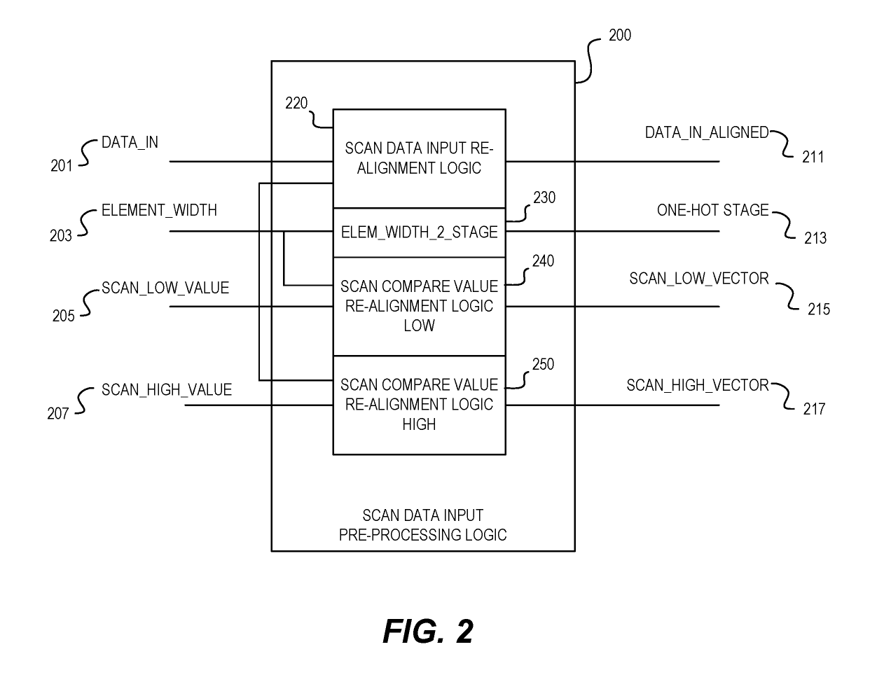

FIG. 1 is a high level diagram illustrating scan processing, in an embodiment. In an embodiment, the scan processing is performed in two stages 101, 103. The first stage 101 is the scan pre-processor. The scan pre-processor, may condition the inputs (e.g., the data, scan compare values and element width information) such that they are readily useful for the scan processor 103. The scan processor 103, may perform the “scan” functionality and performs all computations to generate scan results. Scan processing 103 may be implemented as an n-stage scan tree, as discussed more fully below. The scan data input pre-processor 101 is described in more detail with respect to FIG. 2.

FIG. 2 is a high level diagram illustrating operations of pre-processing logic 200, as shown in FIG. 1 as 101, according to an embodiment. In an embodiment, the scan data input re-alignment logic 220 performs two transformations on the input data. First, the re-alignment logic 220 re-aligns the input data 201 so that each elements falls into the proper lane. In an embodiment, the pre-processing and scan logic may operate on packed 32-bit data. If the data width of the elements to scan, or compare, is 3-bits, then the 32-bit data in may contain 10 3-bit elements, and the first two bits of the next element. Realignment if the input elements is to a lane or width of the next power of 2 that will accommodate the width. For instance, for 1-bit elements, the lane is one bit wide. For 2-bit elements, the lane is two bits wide. For a 3-bit element, the lane will be four bits wide, because three is not a power of two. For a 5-bit element, the lane will be eight bits wide, etc.

The second function of the re-alignment logic is to prepend zeroes to each element, if necessary. To illustrate this, assume that the element width 203 is three bits and the data path is eight bits wide. It should be noted that the element_width 203 is passed through to subsequent stages via the elem_width_2_state logic 230. In addition, the elem_width_2_stage logic 230 transforms the width into a one-hot encoding. In digital circuits, one-hot is a group of bits among which the valid combinations of values are only those with a single high (1) bit and all the others low (0). In an embodiment, the logic 230 transforms the elem-width into a one-hot encoding according to the following:

Case (elem_width)

1:→Stage=000001

2:→Stage=000010

3-4:→Stage=000100

5-8:→Stage=001000

9-16:→Stage=010000

17-32:→Stage=100000.

This one-hot encoding is used later to select which stage of the scan tree to output.

In the example of 3-bit elements in an 8-bit data path, there will be two complete elements in each 8-bit data path. However, the elements need to be aligned. A zero will be prepended to the data to make up four bits. In an example, if the element is 010₂ (i.e., 0102=2₁₀), the element is prepended to make up 0010₂, which is still 2₁₀. For one cycle, two elements are processed in this example. Each element will then occupy each of the two 4-bit lanes of the 8-bit data path. The input data is then output as aligned data 211 to be used in the scan stages.

The scan values are the low and high values to be compared with the elements. For a 6-bit element width for an element in an implementation using dictionary encoded representations of 50 state names, the scan values represent the unique values in the dictionary. For instance, if state names are what is to be compared, and they are stored alphabetically, a match of Alabama would be a scan_low_value 205 equal to the scan_high_value 207 of 000001₂, because Alabama would match the first index. If the match, or scan, is for all states that begin with an “M” then the scan_low_value 205 is 19₁₀ (10011₂) of the 50, and the scan-high_value 207 is 26₁₀ (11010₂). Because the scan values are widths that are not a power of two, they will also need to be re-aligned to the proper lane for comparison with the data element. As discussed above, a 6-bit data element will be aligned to an 8-bit lane, with two prepended zeroes. Thus, in this example, element_width 203 will be six. The scan compare value realignment logic low 240 will re-align the 10011₂ to 0010011₂ to pad up to eight bits, and the scan compare value realignment logic high 250 will re-align the 11010₂ to 0011010₂ to pad up to eight bits. The scan low-vector 215, scan_high_vector 217, the one-hot stage 213, and the aligned data 211 are to be fed into the next phase of the scan processor (103 FIG. 1). It should be noted that in an embodiment, the scan values are shifted to the correct lane, but prepending with a zero is unnecessary when the compare, to be discussed later, is only for the element_width number of bits. The scan values only need to be prepended with zeroes if the comparison is for the entire lane width.

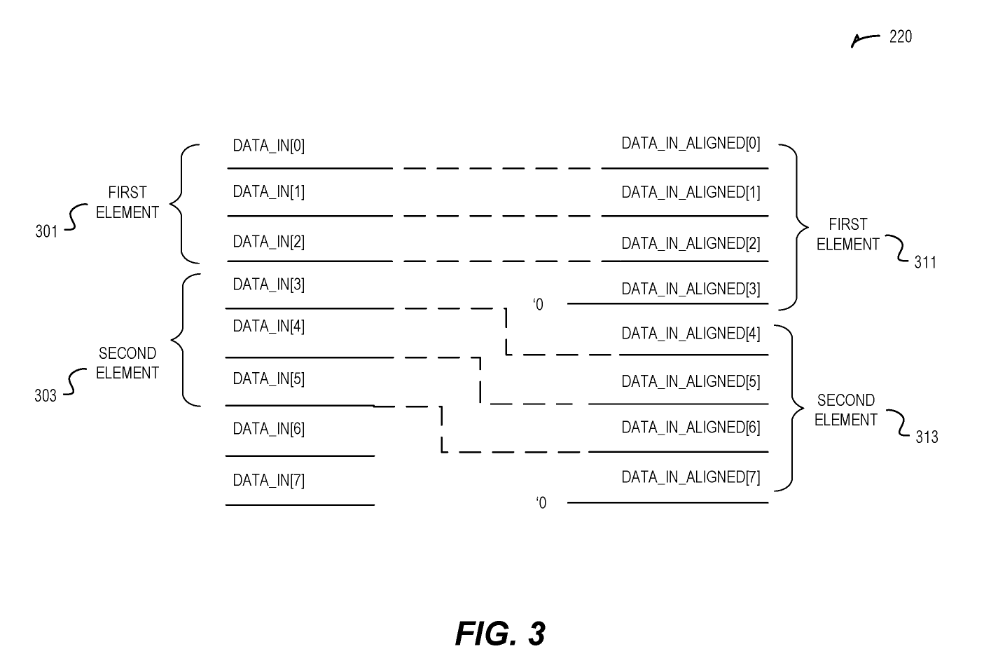

FIG. 3 illustrates the data alignment logic 220 for an example of 3-bit elements. The first element 301 arrives with an 8-bit data path as bits 0-2, e.g., data_in[0], data_in[1], and data_in[2], where bit [0] is the lowest order bit. The second element 303 arrives with an 8-bit data path as bits 3-5. The first element 301 is prepended with a zero at bit three to become aligned first element 311 at bits 0-3. The second element 303 is shifted from bits 3-5 to bits 4-6 and then prepended with a zero at bit seven to become aligned second element 313 at bits 4-7.

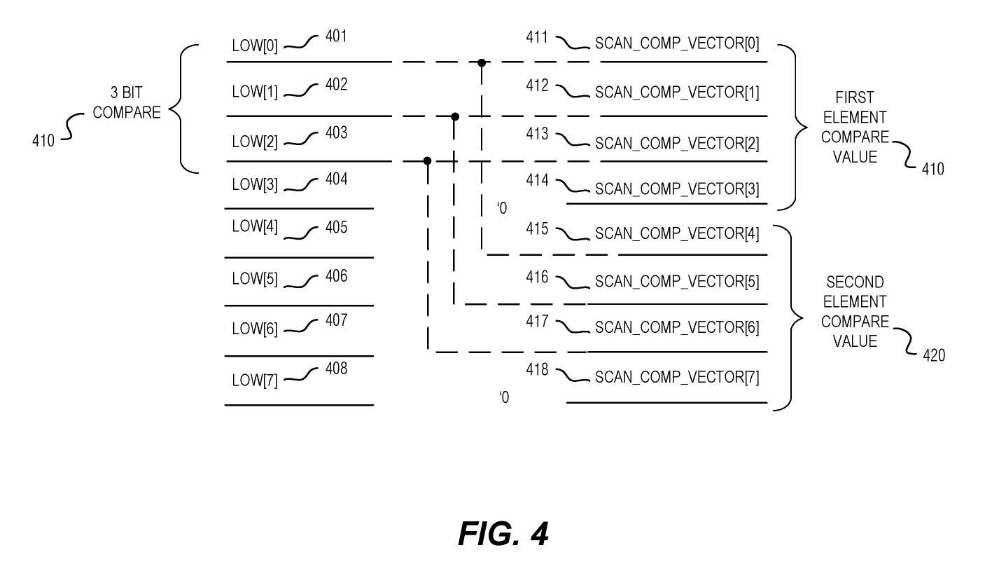

FIG. 4 illustrates how the aligned scan_low_value is compared with the first and second 3-bit elements in an 8-bit data path, in one cycle, according to an embodiment. Since all elements are compared with the same 3-bit scan_low and scan_high values in a cycle, the scan values need not be rewired in each lane for comparison. Instead, the 3-bit scan_low value 410 may be aligned with both the first and second elements in one cycle to result in the first element compare value 410 and the second element compare value 420. In this example, the first element was shifted to comprise bits 0-3 (411-414), and also to the second element at bits 4-7 (415-418). It should be noted that while the scan low value needed to be shifted to the correct lane, there was no need to pad it (e.g., prepend) with a zero because only a 3-bit compare is necessary in this embodiment, based on the element_width 203. In an embodiment, the scan_low_value and the 3-bit elements are prepended or padded with a zero to make a 4-bit wide comparison. Regardless of whether a 3-bit or 4-bit comparison is performed, (e.g., whether the zero bit is ignored or used in the comparison), both the scan_low_value and the element must be shifted into the correct lane. The comparison with the scan_high value (not shown) operates similarly to the scan_low value comparison, but using different inputs.

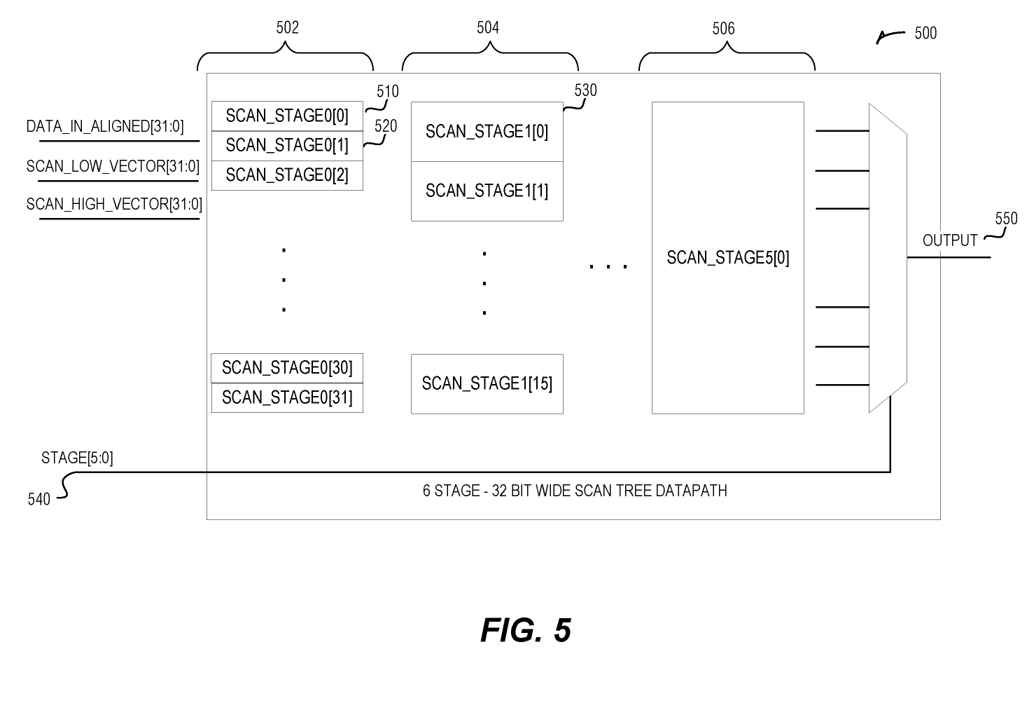

FIG. 5 illustrates an n-stage scan tree 500, representing the scan processor 103 for FIG. 1, for an example of 32-bit data path, according to an embodiment. The scan tree 500 is shown with inputs that result from the pre-processing 101, e.g., aligned data_in, scan_low and scan_high vectors, etc. Each stage logic 502, 504, 506, etc., is configured to perform a 1-bit compare. As will be discussed later, the first scan stage, e.g., Stage0 502 is different than subsequent stages. For a 32-bit data path, six stages are used to perform the low and high scan comparisons. The number of stages required for each compare is dependent upon the element width. For instance, if the element width is 32-bits, then one element may be processed at each cycle, in six stages. If the element width is 1-bit, then 32 elements may be compared in one cycle, in one stage. If the element width is 2-bits, then 16 elements may be compared in one cycle, in two stages. If the element width is 3-bits, then one might think 10 elements could be compared in one cycle. However, in an embodiment, the logic circuits may be implemented in stages to be re-used efficiently to accommodate variable width elements. Thus, any element width that is not a power of two will be realigned to the next power of two, as discussed above. Thus, an element width of 3-bits is aligned to a 4-bit width, and eight 3-bit elements may be compared in one cycle. In other words, eight aligned 4-bit elements is 32 bits. This embodiment may not maximize the number of element comparisons for a specific given width, but instead, optimizes parallel comparisons of elements at each stage and allows for reuse of the logic circuits. Thus, unique logic is not required for all possible element widths, thereby saving hardware and simplifying the circuitry. In other words, a 32-bit data path may be dynamically partitioned to smaller element sizes while maximizing the sharing of the hardware logic. Existing systems require customized circuitry for each possible data width (e.g., 1-bit circuitry, 2-bit circuitry, 3-bit circuitry, etc.) that cannot be reused, which results is much larger hardware configuration to accommodate multiple element width sizes.

In an example, a 32-bit data path of packed data and 3-bit element width will comprise 10 elements (of 3-bits each) and two extra bits for the next element, before realignment. After realignment, the first stage will operate on the first eight elements (e.g. 24-bits of actual data padded to make 32-bits). The leftover bits (e.g., for elements 9-10 and the extra two bits for element 11) will get shifted to the next cycle, as elements 1-2 and partial third element.

The stage[5:0] 540 is used to select which stage to tap to generate the final comparison output, and depends on the data path width and the element width. The element width drives the number of stages that must be calculated to result in a full compare of the element with the low_scan and high_scan values. For instance, a width of 1-bit may be compared in only one stage (e.g., Stage0 502). The first bit is compared at scan_stage0[0] 510. The second bit is compared at scan_stage0[1] 520, and so on. A width of 2-bits may be compared in two stages, because each stage performs only a 1-bit compare. Thus, the 1-bit comparison at stage0 502 is fed into stage1 504 to complete the 2-bit comparison. However, an element width of 3-bits and 4-bits may be compared in three stages because the 3-bit element is realigned to be a 4-bit width. Elements of 5-8 bits may be compared in four stages. Elements of 9-16 bits may be compared in five stages. Elements of 17-32 bits may be compared in six stages, and stage5 506 provides the final result of the comparison. Thus, for a 32-bit data path, only six stages are necessary to compare a variable element width of 1 to 32. It will be understood that a data path of 64-bits will have an additional stage, e.g., a seven stage scan tree. And similarly, a 128-bit data path with have an eight stage scan tree, etc.

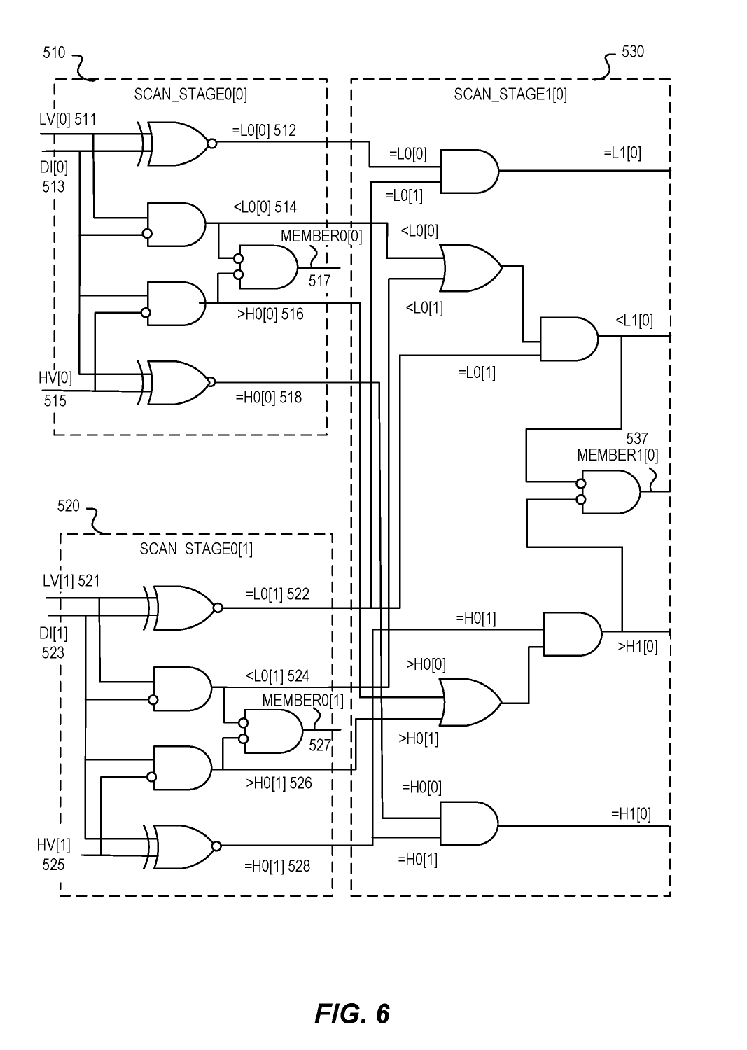

Each stage 502, 504, . . . , 506 receives the output, member*[0:n] from the previous stage, where * indicates the previous stage number, and n indicates the number of bits in the aggregated 1-bit comparisons). In an example, stage0—the first stage—having a 32-bit data path provides 32 bits (0:31) of scanned, or compared data. This is represented as output, member0[31:0]. The second stage performs a 1-bit comparison combining the data_in, element width, and member0[31:0] to provide output, member1[15:0] as shown in FIG. 6.

Thus, it will be understood that output 550 may be multiplexed, or “muxed” as follows. In an embodiment, the first stage will have output member0[31:0], or a 32-bit data with 32 results of 1 bit for each 1-bit compare. The second stage will have output member1[15:0]. It will be understood that in an embodiment, each member* is a 32-bit result with prepended zeroes for results of less than 32 bits. For instance, since stage1 results in 16 bits of comparison results, the first 16-bits in member1 will be zero, The third stage will output member2[7:0], with the first 24-bits as zero, and so on, until stage 6 will have a 1 bit data output member5[0] with the first 31-bits as zero. Depending on the element width, the member* at the proper stage will be selected for output as a result of the scan.

The equation describing the mux is as follows, where a curly bracket indicates that multiple entities are concatenated. For example, member[31:0]={0, member1[15:0]} means that 32-bit output member[31:0] will be assigned 16 bits member1[15:0] padded with zeroes on the left. The result per element (e.g., scan/compare whether each element is within low and high values) is always 1 bit. So, at stage0, there will be 32 1-bit results (member0[31:0]). At stage1 (e.g., when each element is 2-bits wide), there are 16 1-bit results. There will be 16 because there are 16 elements processed in a 32 bit data path when each element is 2-bits wide. For stage5 (when each element is 32-bits) there is only one element to process, and hence the result is a 1-bit result (member5[0]), and padded with zeros to match the 32-bit data path. It will be understood that in a 64-bit data path, for instance, there will be seven stages, and stage0 will result in 0: member[63:0]=member0[63:0]. But stage6 (seventh stage) will still result in a 1-bit compare that is padded with 63 zeroes to match the 64-bit data path. In a 32-bit data path, with a data element width of 32-bits, the results will be as follows.
case (stage)
0: member[31:0]=member0[31:0];
   (e.g., 32-bits of results, EW=1);
1: member[31:0]={0, member1[15:0]};
   (e.g., 16-bits, with 16 prepended zeroes, EW=2);
2: member[31:0]={0, member2[7:0]};
   (e.g., 8-bits, with 24 prepended zeroes); (EW=3-4)
3: member[31:0]={0, member3[3:0]};
   (e.g., 4-bits, with 28 prepended zeroes); (EW=5-8)
4: member[31:0]={0, member4[1:0]};
   (e.g., 2-bits, with 30 prepended zeroes); (EW=9-16)
5: member[31:0]={0, member5[0]};
   (e.g., 1-bit, with 31 prepended zeroes); (EW=17-32)
endcase,
   where EW is the element width, and the notation {0, member-NU:01} indicates that at member level N, bits 0 to I have information, and the rest of the 32 bits are prepended zeros. For instance, in a 32-bit data path, when the element width (EW) is 8-bits, then four elements are scanned in a cycle and 4 bits are output.

FIG. 6 illustrates the logic gates at stage0 (first stage), and logic gates at stage1 (second stage) for a portion of the scan processor 103, according to an embodiment. To simplify the explanation, only two input bits and only the first two stages are shown. It will be understood that this circuitry logic may be scaled to any number of data path widths, in powers of two, e.g., 2, 4, 8, 16, 32, 64, etc. This example circuitry is shown for scan_stage0 502 for the first bit[0] at stage0[0] 510 and for the second bit [1] at stage0[1] 520. The input labels have been abbreviated for simplicity. Inputs for scan_stage0[0] 510 include low_scan_value (LV[0]) 511 for bit 0; data_in (DI[0]) 513 of bit 0, and high_scan_value (HV[0]) 515 for bit 0. Outputs of stage0[0] 510, include equal_low0[0] (=L0[0]) 512, less_than_low0[0] (<L0[0]) 514; greater_than_high0[0] (>H0[0]) 516; equal_high0[0] (=H0[0]) 518; and the member0[0] 517 output result. It will be understood that in the notation equal_low*[n], for instance, the * indicates the stage number, and n indicates the bit number in the comparison. So, equal_low0[0] indicates the result of the scan/comparison at stage0 (first stage) of the data_in bit 0 and the low_value bit 0. It will also be understood that for 1-bit element width, member0[0] is the final result of the comparison for the 1-bit element.

Similarly, in scan_stage0[1] 520, the second bit of the aligned data path (e.g., data_in[1] 523) is compared to the low_value[1] 521, and high_value[1] 525. Outputs of scan_stage0[1] 520, include equal_low0[1] 522, less than_low0[1] 524; greater_than_high0[1] 526; equal_high0[1] 528 with the member0[1] 527 as output result. It will be understood that for a 1-bit width element that member0[1] is the final comparison result for the second bit of data_in[31:0]. For 2-bit data width, the results of scan_stage0[0] 510 and scan_stage0[1] 520 will need to be combined, as in scan_stage1[0] 530.

It will be understood that in embodiments, the main output of the scan processing element is the member signal, which indicates that the input matches the scan compare values. Additional information are calculated which are necessary for downstream scan operations of wider elements. These information are the equal to low 512, 522; equal to high 518, 528; less than low 514, 524; and greater than high 516, 526, as discussed above. Given these information, results from adjacent bit positions may be used to calculate the scan operation for the combined bits.

The circuitry logic for scan_stage0[n] may be represented as the following equations:
Less_than_low=NOT (data_in) AND low_value
Equal_low=(data_in XNOR low_value)
Equal_high=(data_in XNOR high_value)
Greater_than_high=data_in AND NOT(high_value)
member=NOT Less_than_low AND NOT Greater_than_high

The circuitry as shown for scan_stage1 [0] 530 may be used for any of the subsequent stages. Scan_stage1[0] 530 takes as inputs the results from two adjacent bits positions in the previous stage. For instance, in this example, scan_stage1[0] 530 uses the results from scan_stage0[0] 510 and scan_stage0[1] 520, as shown in FIG. 6, and provides member1[0] 537 as the result of high and low comparisons for the two data bits data_in[0] 513 and data_in[1] 523. The equations for stage1[0] and subsequent stages are shown below. Note that the inputs to logic gates are from the previous stage except for the “member” function which uses the results from current stage.
Less_than_low=(less_than_low[0] OR less_than_low[1]) AND equal_low[1]
Equal_low=equal_low[0] AND equal_low[1]
Equal_high=equal_high[0] AND equal_high[1]
Greater_than_high=(greater_than_high[0] OR greater_than_high[1]) AND equal_high[1]
member=NOT Less_than_low AND NOT Greater_than_high

A detailed logic diagram for a 2-bit wide data path, 2-stage scan processor example is shown in FIG. 6. It should be understood that this logic may be used as building blocks for any data path width (power of 2), as discussed above. Moreover, the logic design as described herein may be pipelined depending on the number of logic that can be performed within a cycle. A pipestage may be easily inserted between the stages as long as all control logic are pipelined accordingly. Pipestages are flop stages that can be inserted in the data path to shorten the number of gate delays between flops to achieve higher frequency or throughput. This allows higher scan throughput by simply increasing the width of the data path.

### Exemplary Register Architecture

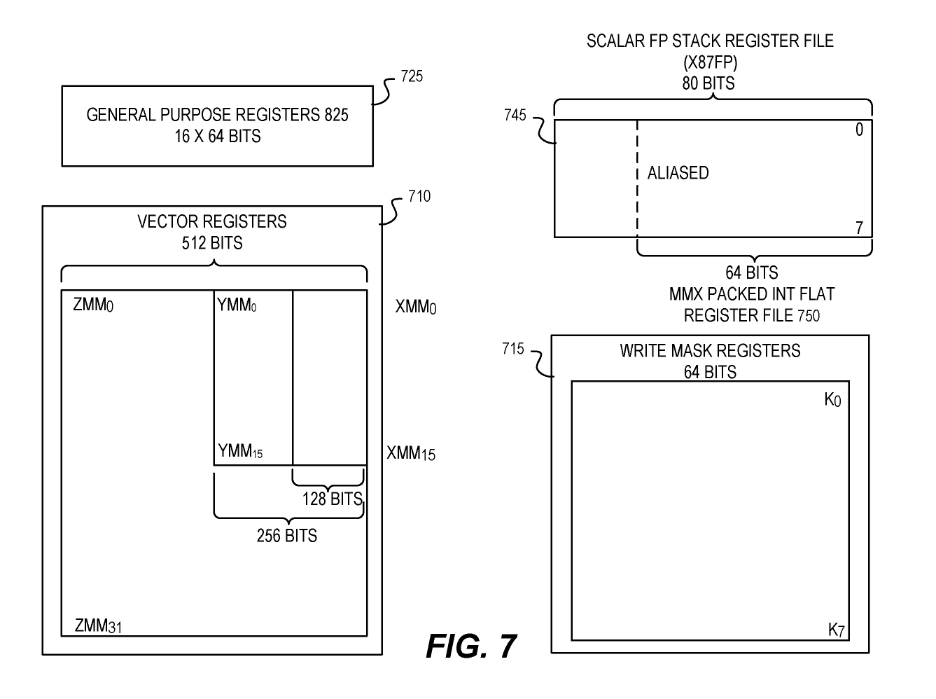

FIG. 7 is a block diagram of a register architecture in a system on which various embodiments described herein may be implemented. In the embodiment illustrated, there are 32 vector registers 710 that are 512 bits wide; these registers are referenced as ZMM₀ through ZMM₃₁. The lower order 256 bits of the lower 16 ZMM registers are overlaid on registers YMM₀₋₁₆. The lower order 128 bits of the lower 16 ZMM registers (the lower order 128 bits of the YMM registers) are overlaid on registers XMM₀₋₁₅.

In write mask registers 715 in the embodiment illustrated, there are 8 write mask registers (K0 through K7), each 64 bits in size. In an alternate embodiment, the write mask registers 715 are 16 bits in size. In an embodiment, the vector mask register K0 may not be used as a write mask; when the encoding that would normally indicate K0 is used for a write mask, it selects a hardwired write mask of 0xFFFF, effectively disabling write masking for that instruction.

General-purpose registers 725, in the embodiment illustrated, comprise sixteen 64-bit general-purpose registers that are used along with the existing x86 addressing modes to address memory operands. These registers may be referenced by the names RAX, RBX, RCX, RDX, RBP, RSI, RDI, RSP, and R8 through R15.

Scalar floating point stack register file (x87 stack) 745, on which is aliased the MMX packed integer flat register file 750, in the embodiment illustrated, the x87 stack is an eight-element stack used to perform scalar floating-point operations on 32/64/80-bit floating point data using the x87 instruction set extension; while the MMX registers are used to perform operations on 64-bit packed integer data, as well as to hold operands for some operations performed between the MMX and XMM registers.

It will be understood that hardware registers may be used for various components of embodiments described herein. In an embodiment input data may be held in one or more registers before being sent to a specialized arithmetic logic unit (ALU) or other logic element. Alternative embodiments may use wider or narrower registers. Register width may be driven by the maximum number of bits for the element width, as discussed above. In another embodiment, narrower registers may be used in double word, quadruple word, etc., fashion. Additionally, alternative embodiments may use more, fewer, or different register files and registers.

### Exemplary Core Architectures, Processors, and Computer Architectures

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Exemplary core architectures are described next, followed by descriptions of exemplary processors and computer architectures.

### Exemplary Core Architectures

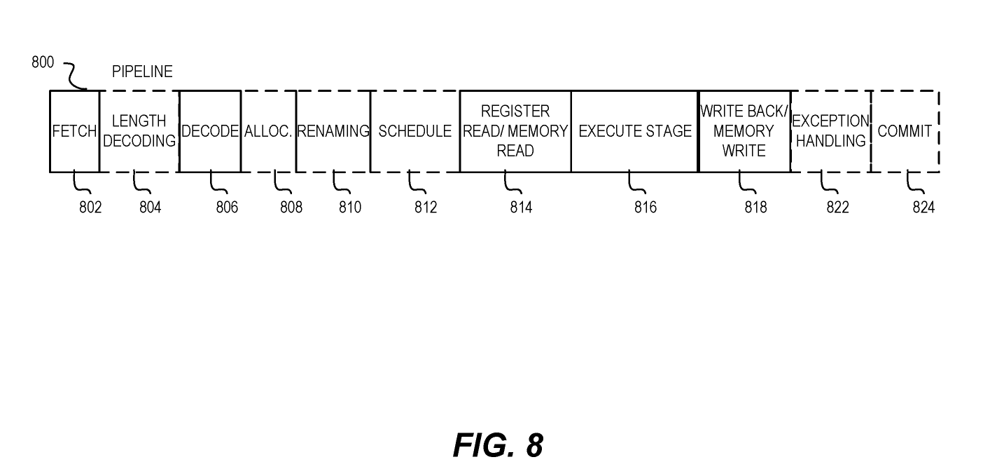

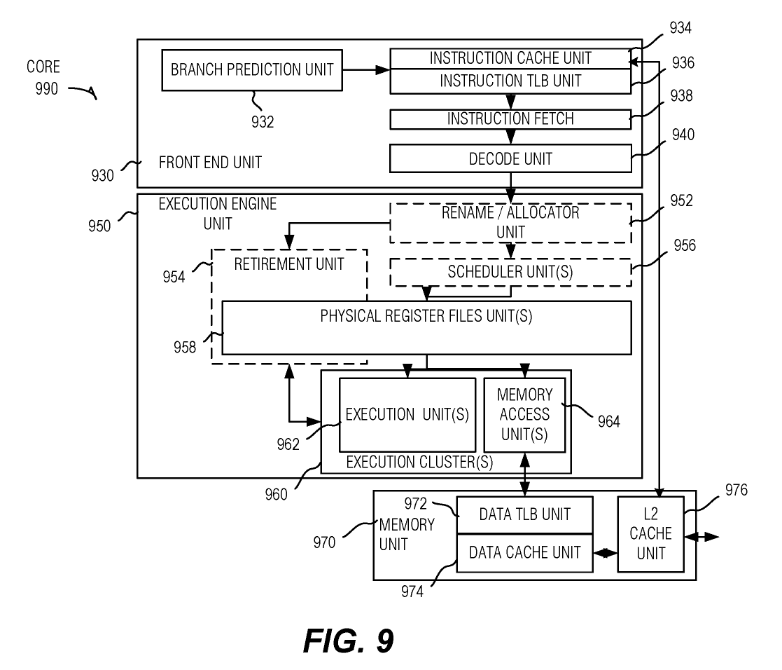

FIG. 8 is a block diagram illustrating both an exemplary in-order pipeline and an exemplary register renaming, out-of-order issue/execution pipeline according to embodiments. FIG. 9 is a block diagram illustrating both an exemplary embodiment of an in-order architecture core and an exemplary register renaming, out-of-order issue/execution architecture core to be included in a processor according to embodiments. The solid lined boxes in FIG. 9 illustrates the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 8, a processor pipeline 800 includes a fetch stage 802, a length decode stage 804, a decode stage 806, an allocation stage 808, a renaming stage 810, a scheduling (also known as a dispatch or issue) stage 812, a register read/memory read stage 814, an execute stage 816, a write back/memory write stage 818, an exception handling stage 822, and a commit stage 824.

FIG. 9 shows processor core 990 including a front end unit 930 coupled to an execution engine unit 950, and both are coupled to a memory unit 970. The core 990 may be a reduced instruction set computing (RISC) core, a complex instruction set computing (CISC) core, a very long instruction word (VLIW) core, or a hybrid or alternative core type. As yet another option, the core 990 may be a special-purpose core, such as, for example, a network or communication core, compression engine, coprocessor core, general purpose computing graphics processing unit (GPGPU) core, graphics core, or the like.

The front end unit 930 includes a branch prediction unit 932 coupled to an instruction cache unit 934, which is coupled to an instruction translation lookaside buffer (TLB) 936, which is coupled to an instruction fetch unit 938, which is coupled to a decode unit 940. The decode unit 940 (or decoder) may decode instructions, and generate as an output one or more micro-operations, micro-code entry points, microinstructions, other instructions, or other control signals, which are decoded from, or which otherwise reflect, or are derived from, the original instructions. The decode unit 940 may be implemented using various different mechanisms. Examples of suitable mechanisms include, but are not limited to, look-up tables, hardware implementations, programmable logic arrays (PLAs), microcode read only memories (ROMs), etc. In one embodiment, the core 990 includes a microcode ROM or other medium that stores microcode for certain macroinstructions (e.g., in decode unit 940 or otherwise within the front end unit 930). The decode unit 940 is coupled to a rename/allocator unit 952 in the execution engine unit 950.

The execution engine unit 950 includes the rename/allocator unit 952 coupled to a retirement unit 954 and a set of one or more scheduler unit(s) 956. The scheduler unit(s) 956 represents any number of different schedulers, including reservations stations, central instruction window, etc. The scheduler unit(s) 956 is coupled to the physical register file(s) unit(s) 958. Each of the physical register file(s) units 958 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 958 comprises a vector registers unit, a write mask registers unit, and a scalar registers unit. These register units may provide architectural vector registers, vector mask registers, and general purpose registers. The physical register file(s) unit(s) 958 is overlapped by the retirement unit 954 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 954 and the physical register file(s) unit(s) 958 are coupled to the execution cluster(s) 960. The execution cluster(s) 960 includes a set of one or more execution units 962 and a set of one or more memory access units 964. The execution units 962 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 956, physical register file(s) unit(s) 958, and execution cluster(s) 960 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 964). It should also be understood that where separate pipelines are used, one or more of these pipelines may be out-of-order issue/execution and the rest in-order. In an embodiment, scan logic may be implemented in execution unit(s) 962 within processor core 990.

The set of memory access units 964 is coupled to the memory unit 970, which includes a data TLB unit 972 coupled to a data cache unit 974 coupled to a level 2 (L2) cache unit 976. In one exemplary embodiment, the memory access units 964 may include a load unit, a store address unit, and a store data unit, each of which is coupled to the data TLB unit 972 in the memory unit 970. The instruction cache unit 934 is further coupled to a level 2 (L2) cache unit 976 in the memory unit 970. The L2 cache unit 976 is coupled to one or more other levels of cache and eventually to a main memory.

By way of example, the exemplary register renaming, out-of-order issue/execution core architecture may implement the pipeline 800 as follows: 1) the instruction fetch 938 performs the fetch and length decoding stages 802 and 804; 2) the decode unit 940 performs the decode stage 806; 3) the rename/allocator unit 952 performs the allocation stage 808 and renaming stage 810; 4) the scheduler unit(s) 956 performs the schedule stage 812; 5) the physical register file(s) unit(s) 958 and the memory unit 970 perform the register read/memory read stage 814; the execution cluster 960 perform the execute stage 816; 6) the memory unit 970 and the physical register file(s) unit(s) 958 perform the write back/memory write stage 818; 7) various units may be involved in the exception handling stage 822; and 8) the retirement unit 954 and the physical register file(s) unit(s) 958 perform the commit stage 824.

The core 990 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 990 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache units 934/974 and a shared L2 cache unit 976, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

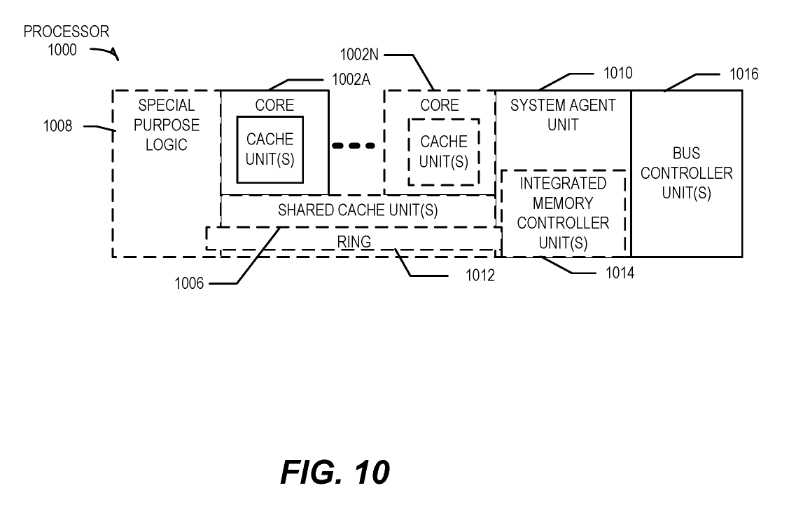

FIG. 10 is a block diagram of a processor 1000 that may have more than one core, may have an integrated memory controller, and may have integrated graphics according to embodiments. The solid lined boxes in FIG. 10 illustrate a processor 1000 with a single core 1002A, a system agent 1010, a set of one or more bus controller units 1016, while the optional addition of the dashed lined boxes illustrates an alternative processor 1000 with multiple cores 1002A-N, a set of one or more integrated memory controller unit(s) 1014 in the system agent unit 1010, and special purpose logic 1008.

Thus, different implementations of the processor 1000 may include: 1) a CPU with the special purpose logic 1008 being integrated graphics and/or scientific (throughput) logic (which may include one or more cores), and the cores 1002A-N being one or more general purpose cores (e.g., general purpose in-order cores, general purpose out-of-order cores, a combination of the two); 2) a coprocessor with the cores 1002A-N being a large number of special purpose cores intended primarily for graphics and/or scientific (throughput); and 3) a coprocessor with the cores 1002A-N being a large number of general purpose in-order cores. Thus, the processor 1000 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 1000 may be a part of and/or may be implemented on one or more substrates using any of a number of process technologies, such as, for example, BiCMOS, CMOS, or NMOS.

The memory hierarchy includes one or more levels of cache within the cores, a set or one or more shared cache units 1006, and external memory (not shown) coupled to the set of integrated memory controller units 1014. The set of shared cache units 1006 may include one or more mid-level caches, such as level 2 (L2), level 3 (L3), level 4 (L4), or other levels of cache, a last level cache (LLC), and/or combinations thereof. While in one embodiment a ring based interconnect unit 1012 interconnects the integrated graphics logic 1008, the set of shared cache units 1006, and the system agent unit 1010/integrated memory controller unit(s) 1014, alternative embodiments may use any number of well-known techniques for interconnecting such units. In one embodiment, coherency is maintained between one or more cache units 1006 and cores 1002-A-N.

In some embodiments, one or more of the cores 1002A-N are capable of multi-threading. The system agent 1010 includes those components coordinating and operating cores 1002A-N. The system agent unit 1010 may include for example a power control unit (PCU) and a display unit. The PCU may be or include logic and components needed for regulating the power state of the cores 1002A-N and the integrated graphics logic 1008. The display unit is for driving one or more externally connected displays.

The cores 1002A-N may be homogenous or heterogeneous in terms of architecture instruction set; that is, two or more of the cores 1002A-N may be capable of execution the same instruction set, while others may be capable of executing only a subset of that instruction set or a different instruction set.

Scan logic may be implemented in a processor 1000 in a variety of difference system architectures. A processor 1000 may be implemented as a central processor unit (CPU), co-processer, ALU, direct memory access (DMA) unit, I/O hub (IOH), or other configuration for execution units or compute nodes, as discussed below.

### Exemplary Computer Architectures

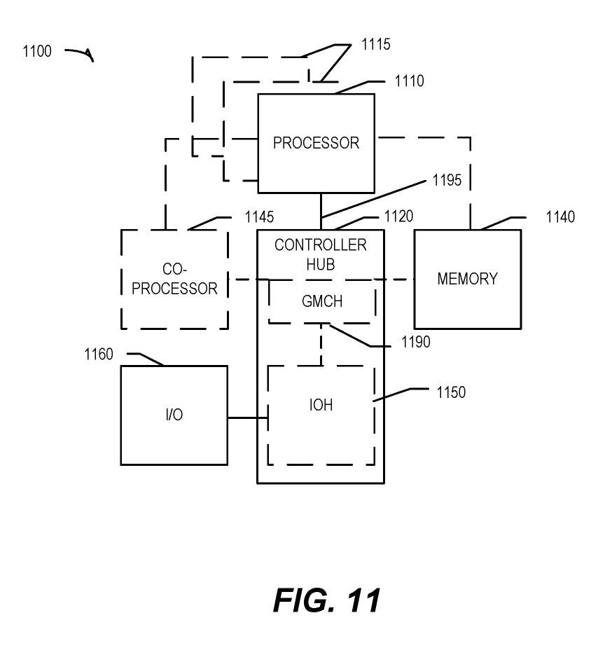

FIGS. 11-13 are block diagrams of exemplary computer architectures on which various embodiments of the pre-processing and scan logic may be implemented. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 11, shown is a block diagram of a system 1100 in accordance with one embodiment of the present invention. The system 1100 may include one or more processors 1110, 1115, which are coupled to a controller hub 1120. In one embodiment the controller hub 1120 includes a graphics memory controller hub (GMCH) 1190 and an Input/Output Hub (IOH) 1150 (which may be on separate chips); the GMCH 1190 includes memory and graphics controllers to which are coupled memory 1140 and a coprocessor 1045; the IOH 1150 is couples input/output (I/O) devices 1160 to the GMCH 1190. Alternatively, one or both of the memory and graphics controllers are integrated within the processor (as described herein), the memory 1140 and the coprocessor 1145 are coupled directly to the processor 1110, and the controller hub 1120 in a single chip with the IOH 1150.

The optional nature of additional processors 1115 is denoted in FIG. 11 with broken lines. Each processor 1110, 1115 may include one or more of the processing cores described herein and may be some version of the processor 1000.

The memory 1140 may be, for example, dynamic random access memory (DRAM), phase change memory (PCM), or a combination of the two. For at least one embodiment, the controller hub 1120 communicates with the processor(s) 1110, 1115 via a multi-drop bus, such as a frontside bus (FSB), point-to-point interface such as QuickPath Interconnect (QPI), or similar connection 1195.

In one embodiment, the coprocessor 1145 is a special-purpose processor, such as, for example, a high-throughput MIC processor, a network or communication processor, compression engine, graphics processor, GPGPU, embedded processor, or the like. In one embodiment, controller hub 1120 may include an integrated graphics accelerator.

There may be a variety of differences between the physical resources 1110, 1115 in terms of a spectrum of metrics of merit including architectural, microarchitectural, thermal, power consumption characteristics, and the like.

In one embodiment, the processor 1110 executes instructions that control data processing operations of a general type. Embedded within the instructions may be coprocessor instructions. The processor 1110 recognizes these coprocessor instructions as being of a type that should be executed by the attached coprocessor 1145. Accordingly, the processor 1110 issues these coprocessor instructions (or control signals representing coprocessor instructions) on a coprocessor bus or other interconnect, to coprocessor 1145. Coprocessor(s) 1145 accept and execute the received coprocessor instructions.

In various embodiments, pre-processing and scan logic may reside in processor(s) 1110, 1115; co-processor 1145; I/O Hub (IOH) 1150, or in the I/O device 1160 itself. It will be understood that the pre-processor and scan logic may reside in the same component 1110, 1115, 1145, 1150 or be distributed between coupled components, and/or separated by buffers or registers.

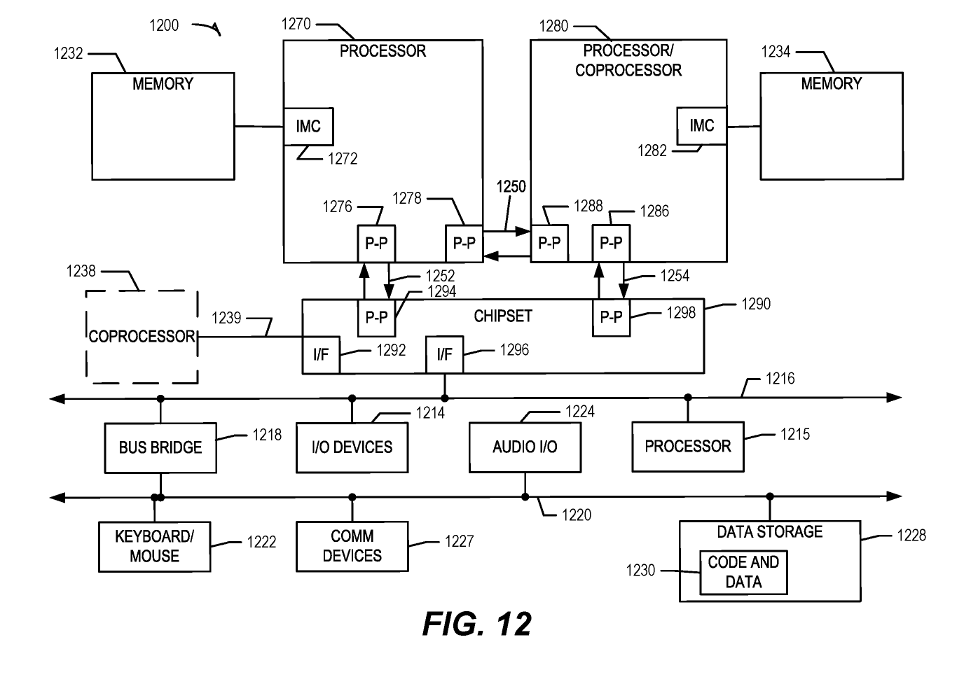

Referring now to FIG. 12 shown is a block diagram of a more specific exemplary system 1200 in accordance with an embodiment described herein. As shown in FIG. 12, multiprocessor system 1200 is a point-to-point interconnect system, and includes a first processor 1270 and a second processor 1280 coupled via a point-to-point interconnect 1250. Each of processors 1270 and 1280 may be a version of any number of processor architecture. In one embodiment of the invention, processors 1270 and 1280 are respectively processors 1110 and 1115, while coprocessor 1238 is coprocessor 1145. In another embodiment, processors 1270 and 1280 are respectively processor 1110 coprocessor 1145, as shown in FIG. 11.

Processors 1270 and 1280 are shown including integrated memory controller (IMC) units 1272 and 1282, respectively. Processor 1270 also includes as part of its bus controller units point-to-point (P-P) interfaces 1276 and 1278; similarly, second processor 1280 includes P-P interfaces 1286 and 1288. Processors 1270, 1280 may exchange information via a point-to-point (P-P) interface 1250 using P-P interface circuits 1278, 1288. As shown in FIG. 12, IMCs 1272 and 1282 couple the processors to respective memories, namely a memory 1232 and a memory 1234, which may be portions of main memory locally attached to the respective processors.

Processors 1270, 1280 may each exchange information with a chipset 1290 via individual P-P interfaces 1252, 1254 using point to point interface circuits 1276, 1294, 1286, 1298. Chipset 1290 may optionally exchange information with the coprocessor 1238 via a high-performance interface 1239. In one embodiment, the coprocessor 1238 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 1290 may be coupled to a first bus 1216 via an interface 1296. In one embodiment, first bus 1216 may be a Peripheral Component Interconnect (PCI) bus, or a bus such as a PCI Express bus or another third generation I/O interconnect bus, although the scope of the present invention is not so limited.

As shown in FIG. 12, various I/O devices 1214 may be coupled to first bus 1216, along with a bus bridge 1218 which couples first bus 1216 to a second bus 1220. In one embodiment, one or more additional processor(s) 1215, such as coprocessors, high-throughput MIC processors, GPGPU's, accelerators (such as, e.g., graphics accelerators or digital signal processing (DSP) units), field programmable gate arrays, or any other processor, are coupled to first bus 1216. In one embodiment, second bus 1220 may be a low pin count (LPC) bus. Various devices may be coupled to a second bus 1220 including, for example, a keyboard and/or mouse 1222, communication devices 1227 and a storage unit 1228 such as a disk drive or other mass storage device which may include instructions/code and data 1230, in one embodiment. Further, an audio I/O 1224 may be coupled to the second bus 1220. Note that other architectures are possible. For example, instead of the point-to-point architecture of FIG. 12, a system may implement a multi-drop bus or other such architecture.

In various embodiments, pre-processing and scan logic may reside in processor(s) 1270, 1280; co-processor 1238; IMC 1272, 1282; I/O devices 1214; or processor 1215. It will be understood that the pre-processor and scan logic may reside in the same component 1270, 1280, 1238, 1272, 1282, 1214, 1215 or be distributed between coupled components, and/or separated by buffers or registers.

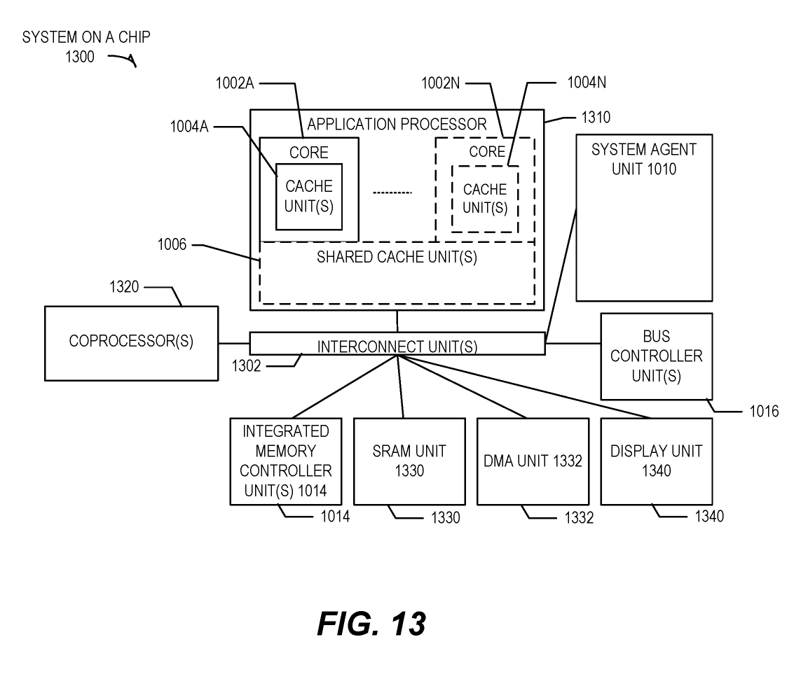

Referring now to FIG. 13, shown is a block diagram of a SoC 1300 in accordance with an embodiment of the present invention. Also, dashed lined boxes are optional features on more advanced SoCs. In FIG. 13, an interconnect unit(s) 1302 is coupled to: an application processor 1310 which includes a set of one or more cores 1002A-N with integrated cache units 1004A-N and/or shared cache unit(s) 1006; a system agent unit 1010; a bus controller unit(s) 1016; an integrated memory controller unit(s) 1014; a set of one or more coprocessors 1320 which may include integrated graphics logic, an image processor, an audio processor, and a video processor; an static random access memory (SRAM) unit 1330; a direct memory access (DMA) unit 1332; and a display unit 1340 for coupling to one or more external displays. In one embodiment, the coprocessor(s) 1320 include a special-purpose processor, such as, for example, a network or communication processor, compression engine, GPGPU, a high-throughput MIC processor, embedded processor, or the like.

In various embodiments, pre-processing and scan logic may reside in the application processor 1310 in a processor core 1002A-N; co-processor 1320; integrated memory controller unit 1014; DMA Unit 1332; or the system agent unit 1010. It will be understood that the pre-processor and scan logic may reside in the same component 1310, 1002A-N, 1320, 1014, 1332, 1010 or be distributed between coupled components, and/or separated by buffers or registers.

Embodiments of the mechanisms disclosed herein may be implemented in hardware, software, firmware, or a combination of such implementation approaches. As discussed above, pre-processing and scan logic ay be implemented in hardware logic or circuitry to gin the benefits and efficiencies as discussed above. Embodiments of the invention may be implemented as computer programs or program code executing on programmable systems comprising at least one processor, a storage system (including volatile and non-volatile memory and/or storage elements), at least one input device, and at least one output device.

Program code, such as code 1230 illustrated in FIG. 12, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

Reference in the specification to “one embodiment” or “an embodiment” means that a particular feature, structure or characteristic described in connection with the embodiment is included in at least one embodiment of the present subject matter. Thus, the appearances of the phrase “in one embodiment” or “in an embodiment” appearing in various places throughout the specification are not necessarily all referring to the same embodiment, or to different or mutually exclusive embodiments. Features of various embodiments may be combined in other embodiments.

For purposes of explanation, specific configurations and details are set forth in order to provide a thorough understanding of the present subject matter. However, it will be apparent to one of ordinary skill in the art that embodiments of the subject matter described may be practiced without the specific details presented herein, or in various combinations, as described herein. Furthermore, well-known features may be omitted or simplified in order not to obscure the described embodiments. Various examples may be given throughout this description. These are merely descriptions of specific embodiments. The scope or meaning of the claims is not limited to the examples given.

Additional examples of the presently described method, system, and device embodiments include the following, non-limiting configurations. Each of the following non-limiting examples may stand on its own, or may be combined in any permutation or combination with any one or more of the other examples provided below or throughout the present disclosure.

### Additional Notes and Examples

Examples may include subject matter such as a method, means for performing acts of the method, or of an apparatus, circuitry or system for a hardware accelerator that offloads the computation from the processor cores and may provide a balanced performance across the entire range of element widths in processing SQL queries.

Example 1 is an apparatus for query acceleration, comprising: scan circuitry to perform 1-bit comparisons of elements of variable M-bit width aligned to N-bit width, where N is a power of 2, in a data path of P-bit width, wherein the circuitry includes: a first stage to calculate 1-bit comparisons of the aligned N-bit width elements to at least one filter provided in an SQL query, and a series of cascading subsequent stages to perform 1-bit comparisons of adjacent comparison results of an immediate preceding stage wherein a total number of cascading subsequent stages is equal log 2(P), and wherein N is either equal to M when M is a power of 2, or to the next-highest value greater than M when M is not a power of 2.

In Example 2, the subject matter of Example 1 optionally includes (N) quantity of cascading subsequent stages.

In Example 3, the subject matter of any one or more of Examples 1-2 optionally include wherein comparisons for multiple elements in the data path are calculated in parallel in the scan circuity, wherein a maximum number of elements, E-max, capable of being calculated in parallel depends on the data path width P and aligned element width N, and wherein E-max=P/N.

In Example 4, the subject matter of any one or more of Examples 1-3 optionally include wherein the first stage comprises input including P bits of data_in, an element width, and a low_boundary value and an high_boundary value, the low_boundary and high_boundary values being derived from the SQL query, the input provided to circuitry to calculate a binary indication of true/false for each of the aligned N-bit elements to be sent to a next cascaded subsequent stage, the binary indications including whether the comparison bit is less than the low_boundary, equal to the low_boundary, equal to the high_boundary, and greater than the high_boundary, and further to calculate a member output using interim calculations of the first stage for an output stage.

In Example 5, the subject matter of Example 4 optionally includes wherein each of the series of cascading subsequent stages is to use calculated results from the previous scan stage for adjacent bits I and J, to result in a multi-bit comparison of an element width that is double that of element width calculated by the previous scan stage.

Example 6 is a hardware scan accelerator, comprising: a data input to receive M-bit wide data elements, wherein M is variable; a data-width input to receive a width indicator representing a data-path width to be used for a current M-bit wide data element; realignment circuitry coupled to the data input and to realign the M-bit wide data elements to N-bit-wide data paths to produce corresponding realigned data elements, wherein N is equal to a power of 2 and is either equal to M when M is a power of 2, or to the next-highest value greater than M when M is not a power of 2; scan circuitry comprising: a first scan stage including single-bit scan circuitry to perform bit-wise value comparisons between the realigned data elements and at least one scan-compare value to produce a first set of compare results; a second scan stage including multi-bit scan circuitry to perform group-wise value comparisons of multi-bit groupings of bits of the first set of compare results to produce a second set of compare results representing group-wise value comparisons between first groups of bits of the realigned data elements and the at least one scan-compare value; and a third scan stage including multi-bit circuitry to perform group-wise value comparisons of multi-bit groupings of bits of the second set of compare results to produce a third set of compare results representing group-wise value comparisons between second groups of bits of the realigned data elements and the at least one scan-compare value, wherein the second groups of bits have more bits than the first groups of bits; and an output stage selector including selection circuitry to determine an output stage from among at least the first scan stage, the second scan stage, and the third scan stage, from which a set of compare results is to be read, wherein the selection circuitry is to determine the output stage based on the data-width input.

In Example 7, the subject matter of Example 6 optionally includes wherein the at least one scan-compare value includes a low-boundary value and an high-boundary value.

In Example 8, the subject matter of any one or more of Examples 6-7 optionally include wherein the first set of compare results include bit-wise indicia representing a match or non-match between the realigned data elements and the at least one compare value.

In Example 9, the subject matter of any one or more of Examples 6-8 optionally include wherein the first set of compare results include bit-wise indicia representing greater-than and less-than relationships between the realigned data elements and the at least one compare value.

In Example 10, the subject matter of any one or more of Examples 6-9 optionally include wherein the first groups of bits comprise adjacent pairs of bits of the first set of compare results.

In Example 11, the subject matter of any one or more of Examples 6-10 optionally include wherein the second groups of bits comprise groupings of four adjacent bits of the first set of compare results.

In Example 12, the subject matter of any one or more of Examples 6-11 optionally include wherein the scan circuitry comprises at least one additional cascaded scan stage coupled to an output of the third scan stage.

In Example 13, the subject matter of Example 12 optionally includes (N).

In Example 14, the subject matter of any one or more of Examples 12-13 optionally include and P is greater than or equal to N.

In Example 15, the subject matter of Example 14 optionally includes (N).

In Example 16, the subject matter of any one or more of Examples 6-15 optionally include wherein each scan stage from among the first and the second scan stages produces compare results of groups of bits of the realigned data elements having double the width of the compare results of corresponding previous scan stage.

Example 17 is a hardware accelerator to accelerate results of SQL queries, comprising: a data input to receive M-bit wide packed data elements in a data path P-bit wide, wherein M is variable between 1 and P; an element-width input to receive a width indicator representing M width to be used for a current M-bit wide data element; at least one scan-compare value for comparison with data elements in the data path, the at least one scan-compare value identified from an SQL query realignment circuitry coupled to the data input and to realign the M-bit wide data elements to N-bit-wide lanes in the data path to produce corresponding realigned data elements, wherein N is equal to a power of 2 and is either equal to M when M is a power of 2, or to the next-highest value greater than M when M is not a power of 2, wherein each of the N-bit wide realigned data elements is padded with N-M zeroes; scan circuitry comprising: a first scan stage including single-bit scan circuitry to perform bit-wise value comparisons between the realigned data elements and at least one scan-compare value to produce a first set of compare results; a second scan stage including multi-bit scan circuitry to perform group-wise value comparisons of multi-bit groupings of bits of the first set of compare results to produce a second set of compare results representing group-wise value comparisons between first groups of bits of the realigned data elements and the at least one scan-compare value; and when 1+log 2(N)>2, at least one additional cascaded scan stage configured similarly to the second scan stage, wherein a total quantity of scan stages is equal to 1+log 2(N); and an output stage selector including selection circuitry to determine an output stage from among at least the first scan stage, the second scan stage, and the at least one additional cascaded scan stage from which a set of compare results is to be read, wherein the selection circuitry is to determine the output stage based on the N-bit wide lanes, wherein the output stage is equal to 1+log 2(N).

In Example 18, the subject matter of Example 17 optionally includes wherein comparisons for multiple elements in the data path are calculated in parallel in the scan circuity, wherein a maximum number of elements, E-max, capable of being calculated in parallel depends on the data path width P and aligned element width N, and wherein E-max=P/N.

In Example 19, the subject matter of any one or more of Examples 17-18 optionally include wherein the first stage comprises input including P bits of data_in, an element width, and a low_boundary value and an high_boundary value, the low_boundary and high_boundary values being derived from the SQL query, the input provided to circuitry to calculate a binary indication of true/false for each of the aligned N-bit elements to be sent to a next cascaded subsequent stage, the binary indications including whether the comparison bit is less than the low_boundary, equal to the low_boundary, equal to the high_boundary, and greater than the high_boundary, and further to calculate a member output using interim calculations of the first stage for an output stage.

Example 20 is a system for query acceleration comprising: a processor coupled to memory to store an in-memory database; scan circuitry communicatively coupled to the processor, when in operation, the scan circuitry to accelerate queries of the in-memory database, wherein the in-memory database is accessible via a Structured Query Language (SQL) query, the scan circuitry to perform 1-bit comparisons of elements of variable M-bit width aligned to N-bit width, where N is a power of 2, in a data path of P-bit width, wherein the circuitry includes: a first stage to calculate 1-bit comparisons of the aligned N-bit width elements to at least one filter provided in an SQL query, and a series of cascading subsequent stages to perform 1-bit comparisons of adjacent comparison results of an immediate preceding stage wherein a total number of cascading subsequent stages is equal log 2(P), and wherein N is either equal to M when M is a power of 2, or to the next-highest value greater than M when M is not a power of 2.

In Example 21, the subject matter of Example 20 optionally includes pre-processing circuitry to receive an M-bit scan query derived from the SQL query, and one or more M-bit elements from the in-memory database and realign the M-bit wide scan query and the one or more M-bit wide elements to N-bit-wide data lanes in the P-bit data path width, to produce corresponding realigned data elements and scan vectors to provide to the scan circuitry for the 1-bit comparisons.

In Example 22, the subject matter of any one or more of Examples 20-21 optionally include wherein the scan circuitry resides in a component coupled to the processor via an interconnect unit, wherein the component comprises one of an integrated memory controller, a co-processor, a direct memory access unit, an arithmetic logic unit, input/output hub, input/output device, or a system agent

In Example 23, the subject matter of any one or more of Examples 20-22 optionally include (N) quantity of cascading subsequent stages.

In Example 24, the subject matter of any one or more of Examples 20-23 optionally include wherein comparisons for multiple elements in the data path are calculated in parallel in the scan circuity, wherein a maximum number of elements, E-max, capable of being calculated in parallel depends on the data path width P and aligned element width N, and wherein E-max=P/N.

In Example 25, the subject matter of any one or more of Examples 20-24 optionally include wherein the first stage comprises input including P bits of data_in, an element width, and a low_boundary value and an high_boundary value, the low_boundary and high_boundary values being derived from the SQL query, the input provided to circuitry to calculate a binary indication of true/false for each of the aligned N-bit elements to be sent to a next cascaded subsequent stage, the binary indications including whether the comparison bit is less than the low_boundary, equal to the low_boundary, equal to the high_boundary, and greater than the high_boundary, and further to calculate a member output using interim calculations of the first stage for an output stage.

In Example 26, the subject matter of Example 25 optionally includes wherein each of the series of cascading subsequent stages is to use calculated results from the previous scan stage for adjacent bits I and J, to result in a multi-bit comparison of an element width that is double that of element width calculated by the previous scan stage.

Example 27 is scan circuitry for acceleration of queries of an in memory database accessed with Structured Query Language (SQL), comprising: circuitry to perform 1-bit comparisons of elements of variable M-bit width aligned to N-bit width, where N is a power of 2, in a data path of P-bit width, wherein the circuitry includes: a first means to calculate 1-bit comparisons of the aligned N-bit width elements to at least one filter provided in an SQL query, and a second means to provide a series of cascading subsequent stages to perform 1-bit comparisons of adjacent comparison results of an immediate preceding stage wherein a total number of cascading subsequent stages is equal log 2(P), and wherein N is either equal to M when M is a power of 2, or to the next-highest value greater than M when M is not a power of 2.

In Example 28, the subject matter of Example 27 optionally includes (N) quantity of cascading subsequent stages.

In Example 29, the subject matter of any one or more of Examples 27-28 optionally include wherein comparisons for multiple elements in the data path are calculated in parallel in the scan circuity, wherein a maximum number of elements, E-max, capable of being calculated in parallel depends on the data path width P and aligned element width N, and wherein E-max=P/N.

In Example 30, the subject matter of any one or more of Examples 27-29 optionally include wherein the first means comprises input including P bits of data_in, an element width, and a low_boundary value and an high_boundary value, the low_boundary and high_boundary values being derived from the SQL query, the input provided to circuitry to calculate a binary indication of true/false for each of the aligned N-bit elements to be sent to a next cascaded subsequent stage, the binary indications including whether the comparison bit is less than the low_boundary, equal to the low_boundary, equal to the high_boundary, and greater than the high_boundary, and further to calculate a member output using interim calculations of the first means for an output stage.

In Example 31, the subject matter of Example 30 optionally includes wherein each of the series of cascading subsequent stages of the second means is to use calculated results from the previous scan stage for adjacent bits I and J, to result in a multi-bit comparison of an element width that is double that of element width calculated by the previous scan stage.

Example 32 is a system to perform operations of any one or more of Examples 1-31.

Example 33 is a method for performing operations of any one or more of Examples 1-31.

Example 34 is a system comprising means for performing the operations of any one or more of Examples 1-31.

The techniques described herein are not limited to any particular hardware or software configuration; they may find applicability in any computing, consumer electronics, or processing environment. The techniques may be implemented in hardware, software, firmware or a combination, resulting in logic or circuitry which supports execution or performance of embodiments described herein.

For simulations, program code may represent hardware using a hardware description language or another functional description language which essentially provides a model of how designed hardware is expected to perform. Program code may be assembly or machine language, or data that may be compiled and/or interpreted. Furthermore, it is common in the art to speak of software, in one form or another as taking an action or causing a result. Such expressions are merely a shorthand way of stating execution of program code by a processing system which causes a processor to perform an action or produce a result.

Each program may be implemented in a high level procedural, declarative, and/or object-oriented programming language to communicate with a processing system. However, programs may be implemented in assembly or machine language, if desired. In any case, the language may be compiled or interpreted.

Program instructions may be used to cause a general-purpose or special-purpose processing system that is programmed with the instructions to perform the operations described herein. Alternatively, the operations may be performed by specific hardware components that contain hardwired logic for performing the operations, or by any combination of programmed computer components and custom hardware components. The methods described herein may be provided as a computer program product, also described as a computer or machine accessible or readable medium that may include one or more machine accessible storage media having stored thereon instructions that may be used to program a processing system or other electronic device to perform the methods.

Program code, or instructions, may be stored in, for example, volatile and/or non-volatile memory, such as storage devices and/or an associated machine readable or machine accessible medium including solid-state memory, hard-drives, floppy-disks, optical storage, tapes, flash memory, memory sticks, digital video disks, digital versatile discs (DVDs), etc., as well as more exotic mediums such as machine-accessible biological state preserving storage. A machine readable medium may include any mechanism for storing, transmitting, or receiving information in a form readable by a machine, and the medium may include a tangible medium through which electrical, optical, acoustical or other form of propagated signals or carrier wave encoding the program code may pass, such as antennas, optical fibers, communications interfaces, etc. Program code may be transmitted in the form of packets, serial data, parallel data, propagated signals, etc., and may be used in a compressed or encrypted format.

Program code may be implemented in programs executing on programmable machines such as mobile or stationary computers, personal digital assistants, smart phones, mobile Internet devices, set top boxes, cellular telephones and pagers, consumer electronics devices (including DVD players, personal video recorders, personal video players, satellite receivers, stereo receivers, cable TV receivers), and other electronic devices, each including a processor, volatile and/or non-volatile memory readable by the processor, at least one input device and/or one or more output devices. Program code may be applied to the data entered using the input device to perform the described embodiments and to generate output information. The output information may be applied to one or more output devices. One of ordinary skill in the art may appreciate that embodiments of the disclosed subject matter can be practiced with various computer system configurations, including multiprocessor or multiple-core processor systems, minicomputers, mainframe computers, as well as pervasive or miniature computers or processors that may be embedded into virtually any device. Embodiments of the disclosed subject matter can also be practiced in distributed computing environments, cloud environments, peer-to-peer or networked microservices, where tasks or portions thereof may be performed by remote processing devices that are linked through a communications network.

A processor subsystem may be used to execute the instruction on the machine-readable or machine accessible media. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Although operations may be described as a sequential process, some of the operations may in fact be performed in parallel, concurrently, and/or in a distributed environment, and with program code stored locally and/or remotely for access by single or multi-processor machines. In addition, in some embodiments the order of operations may be rearranged without departing from the spirit of the disclosed subject matter. Program code may be used by or in conjunction with embedded controllers.

Examples, as described herein, may include, or may operate on, circuitry, logic or a number of components, modules, or mechanisms. Modules may be hardware, software, or firmware communicatively coupled to one or more processors in order to carry out the operations described herein. It will be understood that the modules or logic may be implemented in a hardware component or device, software or firmware running on one or more processors, or a combination. The modules may be distinct and independent components integrated by sharing or passing data, or the modules may be subcomponents of a single module, or be split among several modules. The components may be processes running on, or implemented on, a single compute node or distributed among a plurality of compute nodes running in parallel, concurrently, sequentially or a combination, as described more fully in conjunction with the flow diagrams in the figures. As such, modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured, arranged or adapted by using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

While this subject matter has been described with reference to illustrative embodiments, this description is not intended to be construed in a limiting or restrictive sense. For example, the above-described examples (or one or more aspects thereof) may be used in combination with others. Other embodiments may be used, such as will be understood by one of ordinary skill in the art upon reviewing the disclosure herein. The Abstract is to allow the reader to quickly discover the nature of the technical disclosure. However, the Abstract is submitted with the understanding that it will not be used to interpret or limit the scope or meaning of the claims.

In the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment.

What is claimed is:

1. An apparatus for query acceleration, comprising:
scan circuitry to perform 1-bit comparisons of elements of variable M-bit width aligned to N-bit width, where N is a power of 2, in a data path of P-bit width, wherein the scan circuitry includes:
a first stage to calculate 1-bit comparisons of the aligned N-bit width elements to at least one filter provided in an SQL query, and
a series of cascading subsequent stages to perform 1-bit comparisons of adjacent comparison results of an immediate preceding stage wherein a total number of cascading subsequent stages is equal log 2(P), and
wherein N is either equal to M when M is a power of 2, or to the next-highest value greater than M when M is not a power of 2.

2. The apparatus as recited in claim 1, wherein the scan circuitry is configured so that a total number of required stages for comparison of the M-bit data elements in the P-bit data path is equal to 1+log 2(N) scan stages, wherein the total number of required stages comprise the first stage and log 2(N) quantity of cascading subsequent stages.

3. The apparatus as recited in claim 1, wherein comparisons for multiple elements in the data path are calculated in parallel in the scan circuity, wherein a maximum number of elements, E-max, capable of being calculated in parallel depends on the data path width P and aligned element width N, and wherein E-max=P/N.

4. The apparatus as recited in claim 1, wherein the first stage comprises input including P bits of data_in, an element width, and a low_boundary value and an high_boundary value, the low_boundary and high_boundary values being derived from the SQL query, the input provided to circuitry to calculate a binary indication of true/false for each of the aligned N-bit elements to be sent to a next cascaded subsequent stage, the binary indications including whether the comparison bit is less than the low_boundary, equal to the low_boundary, equal to the high_boundary, and greater than the high_boundary, and further to calculate a member output using interim calculations of the first stage for an output stage.

5. The apparatus as recited in claim 4, wherein each of the series of cascading subsequent stages is to use calculated results from the previous scan stage for adjacent bits I and J, to result in a multi-bit comparison of an element width that is double that of element width calculated by the previous scan stage.

6. A hardware scan accelerator, comprising:
a data input to receive M-bit wide data elements, wherein M is variable;
a data-width input to receive a width indicator representing a data-path width to be used for a current M-bit wide data element;
realignment circuitry coupled to the data input and to realign the M-bit wide data elements to N-bit-wide data paths to produce corresponding realigned data elements, wherein N is equal to a power of 2 and is either equal to M when M is a power of 2, or to the next-highest value greater than M when M is not a power of 2;
scan circuitry comprising:
a first scan stage including single-bit scan circuitry to perform bit-wise value comparisons between the realigned data elements and at least one scan-compare value to produce a first set of compare results;
a second scan stage including multi-bit scan circuitry to perform group-wise value comparisons of multi-bit groupings of bits of the first set of compare results to produce a second set of compare results representing group-wise value comparisons between first groups of bits of the realigned data elements and the at least one scan-compare value; and
a third scan stage including multi-bit circuitry to perform group-wise value comparisons of multi-bit groupings of bits of the second set of compare results to produce a third set of compare results representing group-wise value comparisons between second groups of bits of the realigned data elements and the at least one scan-compare value, wherein the second groups of bits have more bits than the first groups of bits; and
an output stage selector including selection circuitry to determine an output stage from among at least the first scan stage, the second scan stage, and the third scan stage, from which a set of compare results is to be read, wherein the selection circuitry is to determine the output stage based on the data-width input.

7. The hardware scan accelerator as recited in claim 6, wherein the at least one scan-compare value includes a low-boundary value and an high-boundary value.

8. The hardware scan accelerator as recited in claim 6, wherein the first set of compare results include bit-wise indicia representing a match or non-match between the realigned data elements and the at least one compare value.

9. The hardware scan accelerator as recited in claim 6, wherein the first set of compare results include bit-wise indicia representing greater-than and less-than relationships between the realigned data elements and the at least one compare value.

10. The hardware scan accelerator as recited in claim 6, wherein the first groups of bits comprise adjacent pairs of bits of the first set of compare results.

11. The hardware scan accelerator as recited in claim 6, wherein the second groups of bits comprise groupings of four adjacent bits of the first set of compare results.

12. The hardware scan accelerator as recited in claim 6, wherein the scan circuitry comprises at least one additional cascaded scan stage coupled to an output of the third scan stage.

13. The hardware scan accelerator as recited in claim 12, wherein a total quantity of scan stages is equal to 1+log 2(N).

14. The hardware scan accelerator as recited in claim 12, wherein the data input is further to receive the M-bit wide data elements in a packed format in a data path having P-bit width, wherein P is a power of 2, and P is greater than or equal to N.

15. The hardware scan accelerator as recited in claim 14, wherein M is variable from 1 to P for a current scan, wherein the circuitry comprises a total quantity of scan stages equal to 1+log 2(P), and the total quantity of scan stages in the circuitry used for the current scan of M-bit width is 1+log 2(N).

16. The hardware scan accelerator as recited in claim 6, wherein each scan stage from among the first and the second scan stages produces compare results of groups of bits of the realigned data elements having double the width of the compare results of corresponding previous scan stage.

17. A hardware accelerator to accelerate results of SQL queries, comprising:
a data input to receive M-bit wide packed data elements in a data path P-bit wide, wherein M is variable between 1 and P;
an element-width input to receive a width indicator representing M width to be used for a current M-bit wide data element;
at least one scan-compare value for comparison with data elements in the data path, the at least one scan-compare value identified from an SQL query
realignment circuitry coupled to the data input and to realign the M-bit wide data elements to N-bit-wide lanes in the data path to produce corresponding realigned data elements, wherein N is equal to a power of 2 and is either equal to M when M is a power of 2, or to the next-highest value greater than M when M is not a power of 2, wherein each of the N-bit wide realigned data elements is padded with N-M zeroes;
scan circuitry comprising:
a first scan stage including single-bit scan circuitry to perform bit-wise value comparisons between the realigned data elements and at least one scan-compare value to produce a first set of compare results;
a second scan stage including multi-bit scan circuitry to perform group-wise value comparisons of multi-bit groupings of bits of the first set of compare results to produce a second set of compare results representing group-wise value comparisons between first groups of bits of the realigned data elements and the at least one scan-compare value; and
when 1+log 2(N)>2, at least one additional cascaded scan stage configured similarly to the second scan stage, wherein a total quantity of scan stages is equal to 1+log 2(N); and
an output stage selector including selection circuitry to determine an output stage from among at least the first scan stage, the second scan stage, and the at least one additional cascaded scan stage from which a set of compare results is to be read, wherein the selection circuitry is to determine the output stage based on the N-bit wide lanes, wherein the output stage is equal to 1+log 2(N).

18. The hardware accelerator as recited in claim 17, wherein comparisons for multiple elements in the data path are calculated in parallel in the scan circuity, wherein a maximum number of elements, E-max, capable of being calculated in parallel depends on the data path width P and aligned element width N, and wherein E-max=P/N.

19. The hardware accelerator as recited in claim 17, wherein the first stage comprises input including P bits of data_in, an element width, and a low_boundary value and an high_boundary value, the low_boundary and high_boundary values being derived from the SQL query, the input provided to circuitry to calculate a binary indication of true/false for each of the aligned N-bit elements to be sent to a next cascaded subsequent stage, the binary indications including whether the comparison bit is less than the low_boundary, equal to the low_boundary, equal to the high_boundary, and greater than the high_boundary, and further to calculate a member output using interim calculations of the first stage for an output stage.

20. A system for query acceleration comprising:
a processor coupled to memory to store an in-memory database;
scan circuitry communicatively coupled to the processor, when in operation, the scan circuitry to accelerate queries of the in-memory database, wherein the in-memory database is accessible via a Structured Query Language (SQL) query, the scan circuitry to perform 1-bit comparisons of elements of variable M-bit width aligned to N-bit width, where N is a power of 2, in a data path of P-bit width, wherein the circuitry includes:
a first stage to calculate 1-bit comparisons of the aligned N-bit width elements to at least one filter provided in an SQL query, and
a series of cascading subsequent stages to perform 1-bit comparisons of adjacent comparison results of an immediate preceding stage wherein a total number of cascading subsequent stages is equal log 2(P), and
wherein N is either equal to M when M is a power of 2, or to the next-highest value greater than M when M is not a power of 2.

21. The system as recited in claim 20, further comprising pre-processing circuitry to receive an M-bit scan query derived from the SQL query, and one or more M-bit elements from the in-memory database and realign the M-bit wide scan query and the one or more M-bit wide elements to N-bit-wide data lanes in the P-bit data path width, to produce corresponding realigned data elements and scan vectors to provide to the scan circuitry for the 1-bit comparisons.

22. The system as recited in claim 20, wherein the scan circuitry resides in a component coupled to the processor via an interconnect unit, wherein the component comprises one of an integrated memory controller, a co-processor, a direct memory access unit, an arithmetic logic unit, input/output hub, input/output device, or a system agent.

23. The system as recited in claim 20, wherein the scan circuitry includes a total number of required stages for comparison of the M-bit data elements in the P-bit data path, the total number of required stages equal to 1+log 2(N) scan stages, wherein the total number of required stages comprise the first stage and log 2(N) quantity of cascading subsequent stages.

24. The scan circuitry as recited in claim 20, wherein comparisons for multiple elements in the data path are calculated in parallel in the scan circuity, wherein a maximum number of elements, E-max, capable of being calculated in parallel depends on the data path width P and aligned element width N, and wherein E-max=P/N.

25. The scan circuitry as recited in claim 20, wherein the first stage comprises input including P bits of data_in, an element width, and a low_boundary value and an high_boundary value, the low_boundary and high_boundary values being derived from the SQL query, the input provided to circuitry to calculate a binary indication of true/false for each of the aligned N-bit elements to be sent to a next cascaded subsequent stage, the binary indications including whether the comparison bit is less than the low_boundary, equal to the low_boundary, equal to the high_boundary, and greater than the high_boundary, and further to calculate a member output using interim calculations of the first stage for an output stage,
wherein each of the series of cascading subsequent stages is to use calculated results from the previous scan stage for adjacent bits I and J, to result in a multi-bit comparison of an element width that is double that of element width calculated by the previous scan stage.
